(19) United States
(12) Patent Application Publication
(10) Pub. No.: US 2012/0072137 A1
(43) Pub. Date: Mar. 22, 2012

(54) PATCH PANEL MONITORING DEVICE

(75) Inventor: John E. Rathke, Southborough, MA (US)

(73) Assignee: Verizon Patent and Licensing Inc., Basking Ridge, NJ (US)

(21) Appl. No.: 12/887,172

(22) Filed: Sep. 21, 2010

(51) Int. Cl. G06F 19/00; H01R 11/00

(52) U.S. Cl. 702/57; 439/502

(57) ABSTRACT

A system and method including at least one patch panel device interconnected with at least one media line and configured to at least one of receive and transmit a communication signal; and at least one measurement device interconnected with the patch panel through at least one monitoring jumper, wherein the measurement device is configured to capture at least one of a voltage and an impedance from the monitoring jumper, wherein the monitoring jumper is configured to selectively receive an electronic label.

### BACKGROUND

Communication networks require a variety of auxiliary equipment that facilitate the transfer of data as well as the testing or monitoring of network performance. These networks may include circuits with media lines for conveying media signals, which extend from a service provider through one or more junctions before ultimately terminating at a user facility. Typically, communication networks may utilize a patch panel or patch bay, which is a device in which temporary connections can be made between incoming lines and outgoing lines. In addition to acting as a junction, a patch panel may provide for the monitoring of data such as media signals by interconnecting and providing for circuit testing in a convenient manner. Patch panels may be rack mounted units that house a multitude of connections for a number of circuits. The circuits are typically connected to the patch panel with jumpers, and the circuits are manually identified with printed sticky backed or other exteriorly adhered labeling.

The current method of manually labeling the media lines entering and leaving the patch panel is ineffective, time consuming and unreliable as the labels fall off, leaving a media line unidentified. These unidentified media lines may ultimately result in stranded and unused bandwidth, which could be utilized by the end user or the service provider.

Accordingly, there is a need in the art for a robust approach for automatic and continuous monitoring of a simple media patch panel while recording and uploading the information to a database effectively and reliably.

### BRIEF DESCRIPTION OF THE DRAWINGS

While the claims are not limited to the illustrated examples, an appreciation of various aspects is best gained through a discussion of various examples thereof. Referring now to the drawings, illustrative examples are shown in detail. Although the drawings represent the various examples, the drawings are not necessarily to scale and certain features may be exaggerated to better illustrate and explain an innovative aspect of an example. Further, the examples set forth herein are not intended to be exhaustive or otherwise limiting or restricting to the precise form and configuration shown in the drawings and disclosed in the following detailed description.

Exemplary illustrations of the present invention are described in detail by referring to the drawings as follow:

FIG. 1 illustrates an exemplary architecture of a communication network;

FIG. 2 illustrates an exemplary patch panel with monitoring connection;

FIG. 3 illustrates an exemplary patch panel monitoring connection with an analog to digital converter and multiplexer attached;

FIG. 4A illustrates an exemplary jumper with a conductive jacket;

FIG. 4B illustrates an exemplary section view of the jumper having a conductive jacket;

FIG. 5A illustrates an exemplary jumper with an exteriorly positioned conductive element;

FIG. 5B illustrates an exemplary section view of the jumper with the exteriorly positioned conductive element;

FIG. 5C illustrates an exemplary section view of the jumper with an exteriorly positioned conductive element;

FIG. 5D illustrates an exemplary section view of the jumper with an exteriorly positioned conductive element with a conductive jacket around the conductive element; and

FIG. 6 illustrates an exemplary process for monitoring patch panel media.

### DETAILED DESCRIPTION

Various exemplary illustrations of communication interface monitoring jumpers are disclosed for use in measuring circuits with electrical or optical signals, such as with communication networks. One exemplary interface is a patch panel in the form of a device in which temporary connections can be made between components with incoming and outgoing data flow signals. The patch panel may be used for modifying or reconfiguring a communications network or for connecting devices such as test instruments to specific lines. An exemplary patch panel may include a rack mount cabinet or enclosure, a media line interconnected to the patch panel, a jumper for monitoring and measuring resistivity or impedance at communication media connecting patch points, a multiplexer (MX) for serially encoding the measured information an analog to digital converter (ADC) may be used to convert analog signals to digital signals and a selector may be used to select which monitoring jumper is monitored or encoded and may be controlled by the computer. In general, monitoring a patch panel configuration may be accomplished by measuring the resistivity or impedance of a monitoring jumper that connect the component to the patch panel through two corresponding patch points in the component and the patch panel. It should be noted that the measurement hardware requires a small current to be sourced (at the point where the ADC connects) to enable the measurement of the monitoring jumper (r=v/i). Connecting the patch points of the panel to a connector using a small insulating conductor facilitates the measurement of conductivity between the patch points. Few or no active components are required on the patch panel depending on the connector type used.

Labeling of the individual monitoring jumper occurs by encoding the monitoring jumper jacket or other conductive element forming a component of the monitoring jumper with a resistivity by altering the material composition or providing a conductive path between the end points of the monitoring jumper. The monitoring jumper connectors may also be used to make a connection to the small insulating conductor attached to the connector. A laptop or other device is attached to the connector and records the monitoring jumper connection configuration pattern. The configuration pattern may then be transferred to a management system and stored in a database.

An exemplary method may include inserting a media line into a communication socket or patch point of an existing patch panel, inserting a monitoring jumper having a conductive element across the patch panel patch socket, measuring the impedance or conductivity across the monitoring jumper, encoding the conductive element with an electronic or digital label, recording the monitoring jumper connection pattern within a database, and transferring the database to a management system. Additionally, the method may further include attaching a multiplexer and an ADC to the connection between the patch panel and monitoring jumper.

An exemplary patch panel monitoring system may include an exemplary conductive monitoring jumper that may be used with any network, system or device, etc., that generally employs at least one communication media line, such as, but not limited to a lead, a wire, a cable, a connector, or other conduit for providing communication between a first component and any other mating component, e.g., elements of a network, system, device or the like. The conductive monitoring jumper may have standard media end connectors affixed on opposing ends. The standard media end connectors may be insulating conductors of a type that may be attached to the monitoring jumpers for connecting the monitoring jumper to the patch panel or other communication media device. The monitoring jumper may include a fiber jacket or other conductive element that extends between the end connector that is encoded with a serial value based on the resistivity, which provides a conductive path between the first end connector and an opposing end connector. The connector ends of the monitoring jumper may be attached to a variety of test instruments, such as, but not limited to a measurement computer, multi-meters, oscilloscopes or any other known instrument used in measuring voltage or impedance.

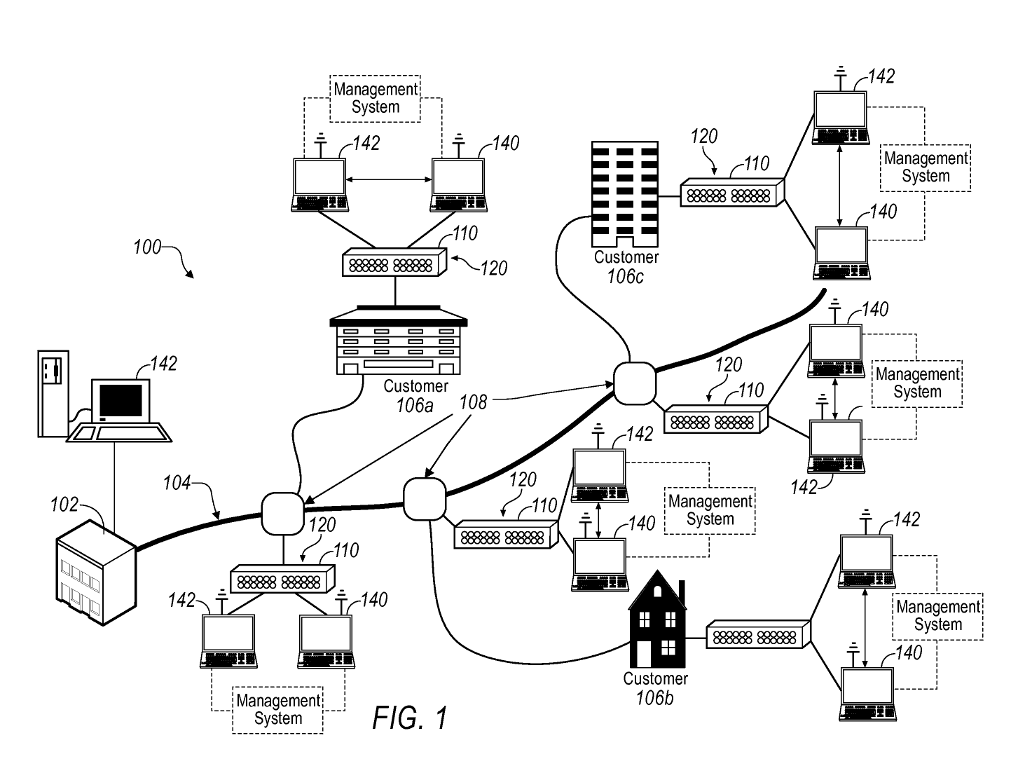

Turning now to FIG. 1, an exemplary communication network 100 is illustrated. The communication network 100 may generally include a central office 102 and a communication line or media 104 that provides communication signals to a plurality of customers 106. The communication media 104 may include any media configured to transmit data, e.g., data wire and optical fibers. The system 100 may be in further communication with additional communications networks and/or systems (not shown), e.g., any known types of media distribution networks, packet-switched networks, telephone networks, or the like.

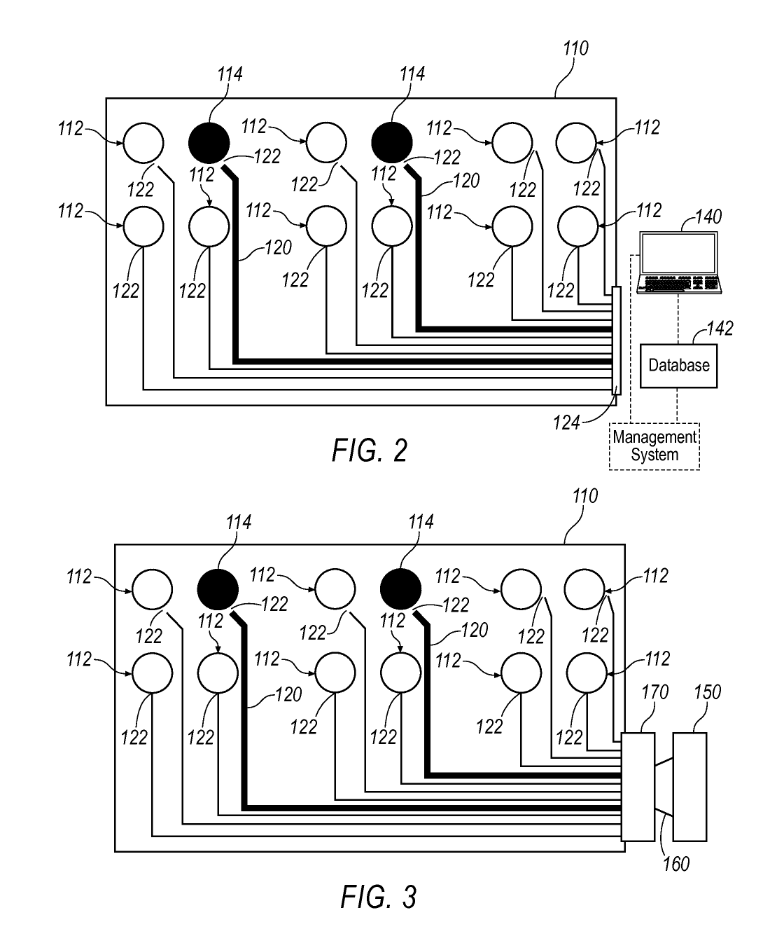

The network 100 may include a plurality of communication switching hubs 108 that may include at least one patch panel 110 and a monitoring jumper 120 (see FIGS. 2-5). The patch panel 110 and monitoring jumper 120 may be associated with the central office 102, a corresponding plurality of customer premises 106 or switching hubs 108. Each switching hub 108 generally processes a signal transmitted through the communication media 104 to provide a desired signal, e.g., optical signals, or the like, to/from an associated customer premise 106 for communicating media content. Where the system 100 includes fiber optic components or media 104, the switching hub 108 may include any other component that is convenient for generally processing optical signals transmitted from a central office 102 through the communication media 104 to the customer(s) 106. The communication media 104 may be secured to each communication switching hub 108, thereby allowing transmission of signals to/from the source 102 and customers 106 through a monitoring jumper 120 and attached patch panel 110.

Additionally, FIG. 1 illustrates the monitoring jumper 120 connecting the patch panel 110 and a monitoring device 140, which may be a computing system having a monitoring program, monitoring connectors (not shown) and a memory device (not shown) for initially storing a reading. As discussed in greater detail below, the monitoring device 140 may store a patch panel configuration or transfer the configuration to a database 142. The database 142 may be integrated with and form a component of monitoring device 140. Alternatively, database 142 may be housed in a separate computing system or server connected either physically through cables or wirelessly to the monitoring 140 or other device.

In general, computing systems (e.g., an illustrative example of monitoring device 140) and/or devices, such as database server housing database 142 and a management system in the form of a computer database stored on a storage media in at least one of the database 142 and the monitoring device 140. The management system may employ any of a number of well known computer operating systems, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Examples of computing devices may include, without limitation, a computer workstation, a server, a desktop, notebook, laptop, or handheld computer, or some other known computing system and/or device.

Computing devices generally include computer-executable instructions, where the instructions may be executable by one or more computing devices such as those listed above. Computer-executable instructions may be compiled or interpreted from computer programs created using a variety of well known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein, with respect to monitoring device 140 and database 142, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system, such as one of those mentioned above, and are accessed via a network in any one or more of a variety of manners, as is known. A file system may be accessible from a computer operating system and may include files stored in various formats. An RDBMS generally employs the known Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

FIG. 2 is an exemplary view of the patch panel 110, interconnected to a plurality of monitoring jumpers 120. The monitoring jumper 120 may be a varied length of conductor or cable used to make a connection between terminals, around a break in a circuit, or around an instrument. The monitoring jumper 120 may be used to connect equipment and cables on a patch panel 110 or route a circuit by linking two cross connect points. The patch panel 110 may include multiple sockets or patch points 112 for connecting a first end 122 of each of a plurality of monitoring jumpers 120. As illustrated, the patch panel 110 may include at least one monitoring connection 114. The monitoring connection 114 allows an technician (not shown) to connect the patch panel 110 to a computer 140 or other device (not shown), which enables the technician to retrieve and transfer patch panel 110 configuration information by measuring a resistance between the monitoring jumpers 120 first 122 and second 124 end connections. The resistance may be measured by the computer 140 or other device configured to measure voltage or impedance, such as, but not limited to an oscilloscope (not shown) or multi-meter (not shown). The configuration information may be directly stored to the computer 140 or transmitted to an auxiliary database 142 for storage and/or distribution.

FIG. 3 is an exemplary illustration of the patch panel 110, interconnected to at least one monitoring jumper 120. FIG. 3 illustrates the use of a multiplexer 150 positioned in the path between the monitoring jumper 120 and the measurement device 140. Additionally, FIG. 3 also includes the use of an ADC 160 and a selector 170. The selector 170 may extend the number of points measured beyond the number of pins on a physical connector 125 that is attached to the computer 140.

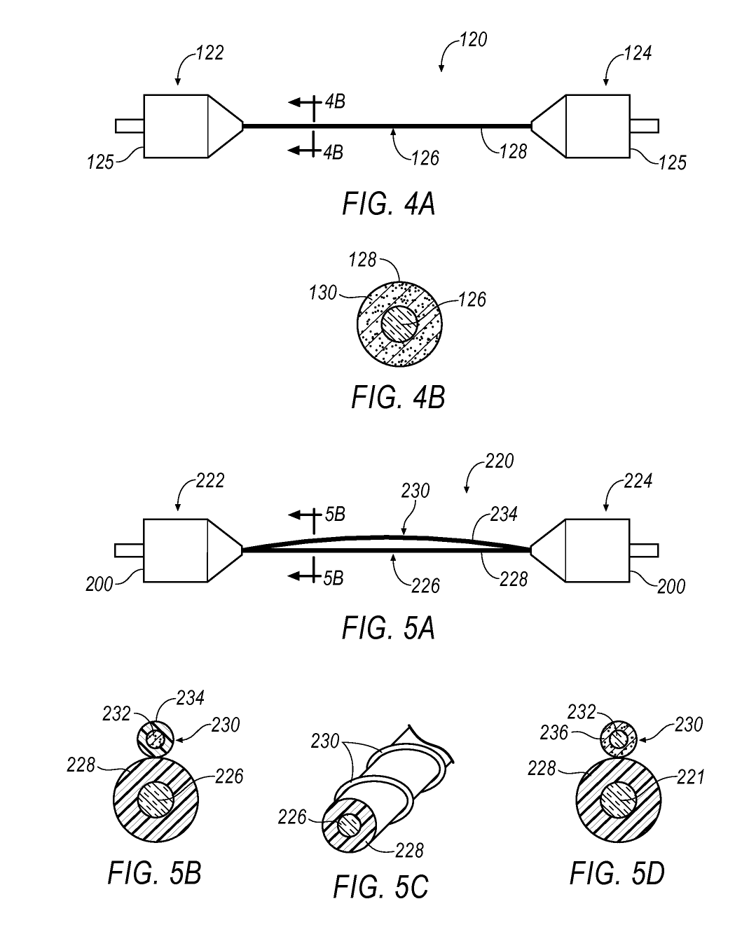

Turning to FIGS. 4A and 4B, an exemplary monitoring jumper 120 is illustrated. The monitoring jumper 120 includes the first end 122 connected to the second end 124 by a media portion 126 that may be encased in a jacket 128. The ends 122, 124 of the monitoring jumper 120 may be standard type connectors 125, such as, but not limited to parallel/serial port connectors, such as, but not limited to D-subminiature connectors (DB9), universal serial bus (USB) connectors or other types of known connectors 125. The media portion 126 may be used to transmit and receive an analog or digital signal. The media portion 126 may include the jacket 128 to protect the media portion 126 from damage or loss of signal. The jacket 128 may be made of a plastic or other suitable flexible or rigid material. The jacket 128 may include a conductive material 130 that may be impregnated into the jacket 128, which may allow the monitoring jumper 120 to be encoded with a value or some other designator for later identification by the monitoring device 140. The first and second ends 122, 124 may also be conductive depending on the application. The conductive material 130 in the jacket 128 may be of any known conductive material, such as, but not limited to carbon or the like.

FIG. 4B further illustrates the conductive material 130 impregnated into the protective jacket 128 representing an outer component of a media cable 126, such as an internal office or interoffice fiber optic media cable extending, for example, between office desks or a server patch panel and a desktop computer. When measuring an interoffice fiber 126, the measurement is analogous to measuring the light propagating in the fiber 126. Specifically, the protective jacket 128 may be attached to the computer 140 and the patch panel 110, which completes a circuit for the computer to measure the resistance or impedance of monitoring jumper 120. It should be known that the impregnation process of the conductive material 130 may be of any random shape or design within the jacket 128 and the corresponding unique configuration is maintained and managed by the management system.

FIG. 5A illustrates an exemplary view of a monitoring jumper 220 with an exteriorly positioned conductive element 230. The monitoring jumper 220 includes standard ends 222, 224 connected by a media portion 226 with a protective jacket 228 and having the conductive element 230 positioned exteriorly of the protective jacket 228. In some instances the monitoring jumper 220 protective jacket 228 may not include the impregnated conductive material 130, as previously discussed, but may include the conductive element 230 that is positioned on an exterior surface of the protective jacket 228. The conductive element 230 may include a protective coating 234 made of plastic or the like. The conductive element 230 may include a conductive core 232 that may be constructed of any known conductive material, such as, but not limited to copper, aluminum, silver, gold or carbon based metals. The conductive element 230 may be affixed to the standard connectors 125, 200 and may extend in any known configuration between the first 222 and second ends 224 of the monitoring jumper 220. Specifically, FIG. 5A illustrates the conductive element positioned outside the media protective jacket 228 running parallel to the media portion 226 and affixed to the conductive connector 125, 200 at each end 222, 224. It should be known that there is no specific pattern used in positioning the exterior conductive element 230. The database may maintain a specific configuration that corresponds to each monitoring jumper 220 and each unique configuration is maintained and managed by the management system.

Turning to FIGS. 5B, 5C and 5D various cross sections are illustrated. FIG. 5B illustrates the media 226 with a conductive element 230 running parallel to and along a longitudinal axis of the media 226. As illustrated, the media 226 has a non-conductive jacket 228, which allows a technician to measure the configuration through the exteriorly affixed conductive element 230 instead of the media 226, as discussed above. FIG. 5C illustrates a cross-section of a conductive element 230, which extends around an outer circumference of the media portion's 226 protective jacket 228. FIG. 5D illustrates a conductive element 230 having both a conductive core 232 and a conductive jacket 236, which may provide a stronger signal for the technician to measure. The conductive jacket 236 may be impregnated in the same manner as discussed above. The conductive jacket may be flexible or rigid depending on the applications. The conductive element 230 is positioned on an exterior surface of the media 226, as shown in FIG. 5D.

Additionally, the exteriorly positioned conductive element 230 may also be made solely of a conductive jacket 236 with or without a conductive core 232, as illustrated in FIG. 5D. FIGS. 5A, 5B, 5C and 5D demonstrate a sample of the unlimited configurations available for positioning the conductive element 230. However, it should be known that the media 226 and the conductive element 230 may be fabricated in any configuration, shape or size that allows for connection to a standard connector 125, 200, as discussed above. Regardless of the shape of the media 226 and the conductive element 230, the measurements of the physically associated path connected to the patch panel 110 will still be measured and downloaded, as discussed above.

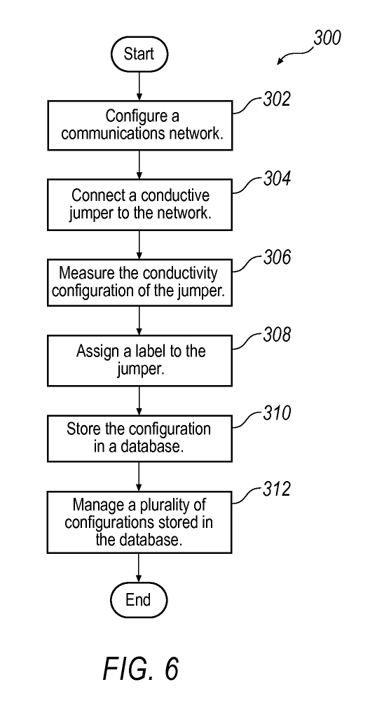

Proceeding now to FIG. 6, an exemplary process for monitoring a patch panel 110 utilizing a monitoring jumper 120, 220 is illustrated. Process 300 may begin at block 302, where a technician configures a communications network 100 with at least one of the communication media 104, switching hubs 108, patch panels 110 and other media devices (not shown), which may be connected to the patch panels 110. The network 100 may be configured to transmit and receive data through the media 104 to and from a central office 102 or a customer 106.

Process 300 may then proceed to block 304. In block 304, the technician may position a monitoring jumper 120, 220 between the patch panel 110 and a measurement device 140, connecting the two and physically associating the monitoring jumper 120, 220 with the connected path. The monitoring jumper 120, 220 may include a conductive element in the form of a conductive jacket 128 impregnated with a conductive element and affixed directly to the media 126; a conductive element 230 having a conductive core 232 and a protective jacket 234 positioned exteriorly of a media portion 226; and a conductive element 230 having a conductive core 232 and a protective jacket 236 that may be conductive and the conductive element 230 may be positioned exteriorly of the media portion 226.

In block 306, the technician may retrieve a conductivity configuration directly from the connected path. The conductivity retrieved may be at least one of a resistance or impedance measured from the monitoring jumper 120, 220 connection. The connection is not limited to any specific device, but can be of any known media connection between two devices provided the media includes the previously discussed conductive elements. In some instances, as previously discussed, a selector 170, a multiplexer 150 and an analog to digital converter 160 may be attached to the patch panel 110. When the selector 170 is used, the technician connects the measuring computer device 140 with the monitoring jumper 120, 220 to connect the two points. The selector allows the technician to extend the number of points measured beyond the number of pins on the physical connector 125, 200 on the computer by switching between attached devices. This allows the technician to monitor multiple devices on a patch panel 110.

Upon retrieval of the configuration, the process may proceed to block 308 where the measuring device assigns a label to the monitoring jumper 120, 220 by encoding the conductive portion of the monitoring jumper 120, 220 with the multiplexer or other known device. The encoding assigns a value to mark the specific circuit for later identification. Once the monitoring jumper 120, 220 is encoded with the specific value, the process may proceed to block 310, where the technician may transfer the configuration to a database 142. The database 142 may be a separate device from the measurement device 140 or an integral part of the measurement device 140. It should be known that the storage of the configuration to the database may take place before or after labeling as defined in block 308 or it may simultaneously with the labeling.

Once the configuration is stored in the database 142, the process proceeds to block 312 where the technician may utilize a predetermined management system to monitor and manage the configurations of a plurality of monitoring jumpers 120, 220 within one database 142. The monitoring allows the technician to control an unlimited number of monitoring jumpers 120, 220. Additionally, it should be known that once the specific monitoring jumper 120, 220 is removed, this signifies to the technician that the specific patch panel 110 socket 112 is free, allowing new devices to be implemented or to free any bandwidth for other devices still attached to the patch panel 110.

An exemplary method may include providing a media network having a plurality of media lines; inserting the media line into a communication socket; connecting the communication socket to a patch panel; inserting a monitoring jumper across a patch socket in a patch panel; connecting a measurement device to the monitoring jumper; taking a measurement from the monitoring jumper; labeling the monitoring jumper with an electronic label; recording the monitoring jumper configuration pattern; and transferring the configuration pattern, including electronic label, to a database. The method may further include providing a management system to the database; measuring at least one of an impedance and a conductivity of the monitoring jumper; and encoding a conductive monitoring jumper with a serial value for the electronic labeling. Additionally, the method may include attaching at least one of a multiplexer and an analog to digital converter to the patch panel patch socket; and converting the measurement from analog to digital.

Reference in the specification to “one example,” “an example,” “one embodiment,” or “an embodiment” means that a particular feature, structure, or characteristic described in connection with the example is included in at least one example. The phrase “in one example” in various places in the specification does not necessarily refer to the same example each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “the,” etc. should be read to recite one or more of the indicated elements unless a claim recites an explicit limitation to the contrary.

What is claimed is:

1. A method comprising:
attaching a monitoring jumper to an interface selectively connected to a communication device;
connecting a measurement device to the monitoring jumper;
taking a measurement from the monitoring jumper; and
labeling the monitoring jumper with an electronic label.

2. The method of claim 1, the electronic label comprising a monitoring jumper configuration pattern and selectively recording the monitoring jumper configuration pattern.

3. The method of claim 2, further comprising transferring the configuration pattern to a database.

4. The method of claim 3, further comprising providing a management system for monitoring and managing the configuration patterns within the database.

5. The method of claim 1, the monitoring jumper including at least one conductive element representing at least an aspect of the electronic label.

6. The method of claim 1, further impregnating the conductive element into a jacket representing an outer component of the monitoring jumper.

7. The method of claim 1, further comprising identifying the electronic label by measuring at least one of an impedance and a conductivity.

8. The method of claim 1, the electronic label comprising a conductive element and encoding a serial value into the conductive element.

9. The method of claim 1, further comprising attaching a multiplexer to the interface, the multiplexer enabling a single measuring device to monitor a plurality of devices through at least one monitoring jumper.

10. The method of claim 1, further comprising attaching an analog to digital converter (ADC) between the monitoring jumper and the interface.

11. The method of claim 10, further comprising converting a measurement from analog to digital.

12. A monitor jumper comprising:
at least one media cable extending between a first end and a second end;
at least one connector affixed to at least one of the first end and the second end; and
at least one conductive element extending between the first end and the second end, wherein the conductive element is configured to receive a configuration pattern.

13. The monitoring jumper of claim 12, wherein the configuration pattern is a serial value.

14. The monitoring jumper of claim 12, wherein the conductive element is a protective cable jacket with at least one conductive material impregnated into the jacket.

15. The monitoring jumper of claim 14, wherein the conductive element is a separate conductive cable extending between the first and second connectors and around an outer circumference of media cable.

16. The monitoring jumper of claim 12, wherein the conductive element is a protective cable jacket with at least one conductive material impregnated into the jacket of a separate conductive cable, wherein the two conductive elements extend around and outer circumference of the media cable.

17. A device comprising:
a patch panel;
a monitoring jumper in communication with the patch panel;
a measurement device in communication with the monitoring jumper; wherein the measurement device is configured to read a monitoring jumper configuration pattern; and
an electronic label affixed to the monitoring jumper, wherein the electronic label is configured to receive a value corresponding to the configuration pattern.

18. The device of claim 17, the electronic label is configured to record the monitoring jumper configuration pattern.

19. The device of claim 17, further comprising a database configured to receive and store the configuration pattern.

20. The device of claim 19, further comprising a management system configured to monitor and manage the configuration patterns within the database.

21. The device of claim 17, wherein the monitoring jumper includes at least one conductive element comprising at least an aspect of the electronic label.

22. The device of claim 21, wherein the conductive element is impregnated into a jacket representing an outer component of the monitoring jumper.

23. The device of claim 21, wherein the measurement device reads at least one of an impedance and a conductivity to identify the electronic label.

24. The device of claim 21, the electronic label comprising a conductive element and encoding a serial value into the conductive element.

25. The device of claim 21, further comprising:
a multiplexer in communication with the patch panel, the multiplexer enabling a single measuring device to monitor a plurality of devices through at least one monitoring jumper; and
an analog to digital converter (ADC) positioned between the monitoring jumper and the patch panel, wherein the ADC converts a measurement from analog to digital.
